(19) United States
(12) Patent Application Publication
(10) Pub. No.: US 2002/0146294 A1
(43) Pub. Date: Oct. 10, 2002

(54) Expandable tooling plate for printed circuit board panel drilling machines

(75) Inventor: Henry Ramirez Martinez, Torrance, CA (US)

Correspondence Address: LOWE HAUPTMAN GILMAN & BERNER, LLP, 1700 Diagonal Road, Suite 310, Alexandria, VA, 22314, US

(73) Assignee: Excellon Automation Co.

(21) Appl. No.: 09/895,407

(22) Filed: Jul. 2, 2001

Related U.S. Application Data
(60) Provisional application No. 60/281,803, filed on Apr. 6, 2001.

(51) Int. Cl. B23B 35/00

(52) U.S. Cl. 408/1 R; 408/91

(57) ABSTRACT

Drilling apparatus includes a stationary support base and a worktable mounted to the support base for movement in a Y direction. At least one tooling plate is movably mounted to the support base for movement in the Y direction and is adapted to support the panel shaped workpiece thereon. At least one tooling element is mounted for movement in X and Z directions in relation to the tooling plate for machining contact with the panel. Coordinated movement of the tooling element in the X direction with movement of the worktable in the Y direction enables a predetermined pattern of holes to be drilled into one end of the panel. Following this coordinated drilling movement, the worktable is maintained in a stationary position while the tooling plate shuttles from a first position to a second position in the Y direction to move the panel and expose the other end portion to subsequent coordinated X and Y movement of the tooling element and worktable to drill a further predetermined hole pattern into the panel. A method of drilling hole patterns into the entire length of the panel is also disclosed.

### TECHNICAL FIELD

The present invention relates generally to setting fixtures for supporting panel-shaped workpieces in registration with one or more tool and tool holders. More particularly, the invention relates to a tooling plate used for supporting printed circuit board panels in registration with one or more spindles containing drilling tools.

### BACKGROUND ART

Drilling machines are commonly used in the manufacture of printed circuit boards (PCBs) to drill a large number of holes through one or more PCB panel substrates. Such machines typically include a heavy machine base on which is disposed a worktable supporting one or more tooling plates respectively formed with a registration and clamping system for supporting and maintaining the panels at predetermined locations on the associated tooling plate. To achieve large scale manufacturing throughput, the drilling machine may be formed with a plurality of tooling plates that are fixedly mounted to the worktable at longitudinally spaced intervals to respectively locate one or more stacks of panel substrates beneath a corresponding number of overhead mounted drilling spindles. These drilling spindles are typically computer controlled and movable along an X axis to respectively drill holes at predetermined locations through each stack. Computer controlled movement of the worktable along the Y axis correspondingly moves the tooling plates in the Y-Y direction to facilitate simultaneous drilling of predetermined hole patterns through each stack.

The foregoing arrangement is satisfactory for drilling hole patterns in printed circuit board panels up to a predetermined panel length equal to or slightly less than the length of the tooling plate in the Y direction. However, there is a major effort currently underway to rebuild the telecommunications and internet infrastructure so that wireless products can be enabled. Many of these infrastructure products require large back-planes to integrate digital, analog and RF subsystems all on one printed circuit board panel unit. The length of such panels typically exceeds the tool plate length of existing machines and, therefore, there exists a capacity shortage of machines for manufacturing and drilling these large panels.

It is accordingly one object of the invention to both provide new, and retrofit existing, drilling machines to accommodate the manufacture of larger panel sizes (e.g. 36×60″ or up to 36×72″ in size).

One solution to enable drilling of large length panels is to manufacture drilling machines having larger bases and worktables in the Y direction. However, bigger machines are sometimes too large and heavy to transport via economical means since there are practical limits to container size in trucks as well as sea-going and air freight transport systems. There are also accuracy issues and attendant problems inherent in larger machine dimensions.

Another object of the invention is to manufacture drilling machines capable of drilling larger length panels without increasing machine width along the Y axis in relation to existing machines.

Other solutions for drilling larger length panels involve dismantling of bigger machines into pieces for solving the transport problems mentioned above. However, this necessitates additional time and expense in relation to machine dismantling and re-assembly and also creates potential accuracy and alignment problems inherent in machine re-assembly.

Another approach to drilling larger length panels on existing machines involves the removal of the panel from the machine after a portion of the panel (along the Y axis) is drilled, so that the panels can be turned around to finish the drilling of the remaining portions. However, this approach involves the need for additional labor or other handling equipment for removing, turning, and re-attaching the panels to the tooling plates, and may further result in alignment problems associated with such panel removal.

Still another object is to drill larger length panels without turning the panels in relation to the tooling plate(s).

Yet another object is to drill virtually any size panel by modifying the manner in which the tooling plate is supported by and interacts with the work table.

### DISCLOSURE OF THE INVENTION

Apparatus for performing a machining operation on at least one panel shaped workpiece, in accordance with the invention, comprises a support base and a worktable mounted to the support base. At least one tooling plate is movably mounted to the support base and adapted to support the panel shaped workpiece. At least one tooling element is movably mounted in relation to the tooling plate and is operable to perform the machining operation. In accordance with the invention, the tooling plate is movable between first and second positions relative to the worktable to thereby correspondingly move the panel workpiece and expose different end portions of the panel to the machining operation.

The feature of shuttling the tooling plate between first and second positions advantageously enables the surface along the entire length of the panel to be exposed to the machining operation. This is particularly useful in the drilling of holes in printed circuit board panels in the printed circuit board industry since the feature of shuttling the tooling plate between the two positions enables larger panels to be drilled.

A method embodying the foregoing movements is also disclosed. The method comprises the steps of positioning the work piece on a tooling plate and then moving a tooling element into machining contact with an end portion of the work piece. After this end portion is machined, the panel is then moved to locate the other end portion of the panel beneath the tooling element. Machining contact between the tooling element and this other end portion of the panel then commences.

In one embodiment, the panel is moved by moving the tooling plate from a first position to a second position, this movement occurring between the successive machining operations. The tooling plate is moved in a Y direction between the successive machining operations which occur in X and Z directions relative to each end portion of the panel.

In accordance with another aspect of the inventive method, only a portion of the tooling plate is moved. This portion is a registration portion on which the panel is adapted to be interlocked after movement occurs and before machining operations are resumed.

The method according to this alternate aspect of the invention involves the further use of a stationary tooling plate portion adapted to support a portion of the panel as the panel is moved by the moveable tooling plate portion. This stationary tooling plate portion is adapted to receive, for example, an edge clamp module, and other types of modules that are not registration sensitive. In this aspect of the invention, the moveable tooling plate allows securing of the registration apparatus (i.e., panel mounted to moveable tooling plate) one time and the ability to change other parts of the tooling plate for different functions without disturbing the registration alignment.

In accordance with a further aspect of the method of the invention, the panel may be mounted to a stationary tooling plate and then moved in a Y direction between first and second end positions to successively locate opposite ends of the panel in proximity to the tooling element. The tooling plate is stationary and the panel is moved in the Y direction by means of one or more conveyor belts. These belts preferably have an upper run adapted to be lifted through a slot formed in the top surface of the tooling plate and into pressing contact with a bottom surface of the panel. Subsequent conveyorized movement of the conveyor belt after lifting is operable to advance the panel between the first and second positions.

As will be evident from the above, the preferred embodiment contemplates a shuttling movement of the tooling plate in a Y direction between the first and second positions. However, once the tooling plate and thereby the panel are moved into one of the first and second positions, both the method and apparatus according to this invention contemplate mechanism and functionality that locks the tooling plate to a supporting worktable, whereupon the worktable is movable in the Y direction as the tooling element, preferably a spindle supporting a drill, is movable in an X and Z direction, enabling large size panels (e.g. 30″×60″ or 30″×72″) to be drilled along the entire panel length.

Other embodiments within the scope of this invention are contemplated wherein the panel is movable in the Y direction after drilling operations have been performed in one end of the panel to thereby expose the other end of the panel.

In accordance with a first preferred embodiment of the invention, the entire tooling plate is moveable into the first and second positions after one end of the panel has been machined in order to then expose the other end of the panel to machining operations.

In accordance with a further embodiment of this invention, the tooling plate includes a moveable portion and a stationary portion. The moveable portion is operable to move the panel after the machining operation of the first end occurs and before the machining operation of the second end starts. The stationary portion is operable to support panel clamping apparatus and other types of equipment that are not used in the process of accurately registering the panel on the tooling plate.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

FIG. 1 is a perspective view illustration of a drilling machine in accordance with one preferred embodiment of the present invention;

FIG. 2 is a perspective view, partially exploded and partly in schematic form, to depict certain additional characteristics and moving mechanisms disposed between the base, worktable, and tooling plate of the invention;

FIG. 3 is a top plan view, partly in schematic form, depicting the positional relationships between one of the tooling plates and the worktable of the invention;

FIG. 3A is a sectional view taken along the line 3A-3A of FIG. 3;

FIG. 3B is a sectional view taken along the line 3B-3B of FIG. 3;

FIG. 4 is a sectional view taken along the line 4-4 of FIG. 3 and is a scaled engineering drawing with nominal exemplary dimensions of one preferred embodiment of the invention;

FIG. 4A is a view similar to FIG. 4 but depicting a locking mechanism for locking the tooling plate to the worktable in the first or second position;

FIG. 4B is a side elevational view of the assembly to depict the use of shock absorbing mechanisms at opposite ends of each tooling plate to slowly stop the tooling plate as it reaches the first or second position;

FIG. 5 is a top plan view, in schematic form, of a four tooling plate (four station) machine according to the invention in which the tooling plate is depicted in a dotted line first position and a solid line second position relative to the worktable;

FIG. 6 is a top plan view in schematic form of a machine having a conventional tooling plate design;

FIG. 7 is a top plan schematic view of another conventional tooling plate design;

FIGS. 8 and 9 are top plan schematic views of the tooling plate of the present invention in first and second positions, respectively;

FIG. 10 is a perspective view of a second embodiment of the moving mechanisms disposed between the base, work table, and tooling plate of the invention;

FIG. 11 is a perspective view of a third embodiment of the invention;

FIG. 12 is a perspective view of a belt drive mechanism associated with the FIG. 11 third embodiment; and

FIGS. 13a, 13b, and 13c are top plan views, partly in schematic form, of the FIG. 2 embodiment, and variations in the design of the FIG. 10 embodiment.

### BEST MODE FOR CARRYING OUT THE INVENTION

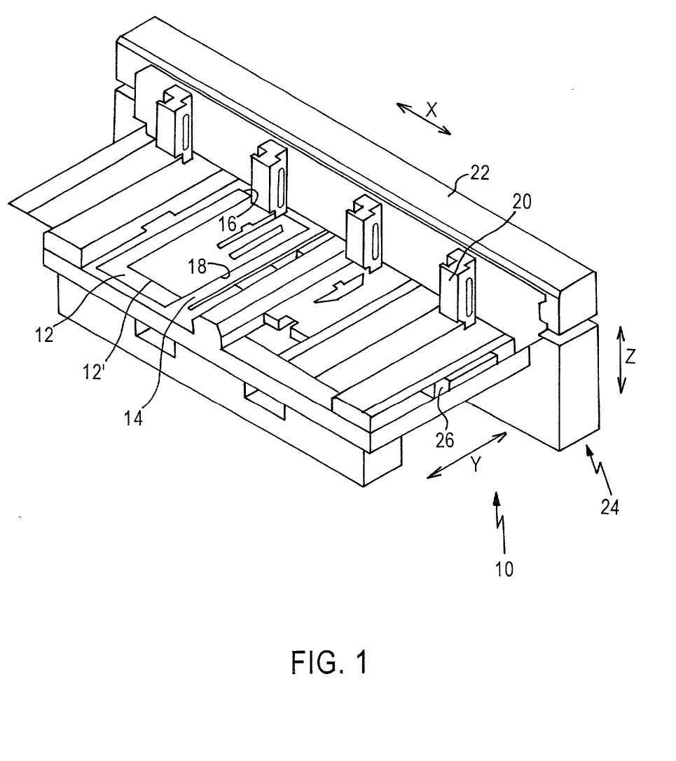

Reference is initially made to FIG. 1 wherein there is disclosed a preferred embodiment of a drilling machine 10 according to the invention in which one or more stacked (or single) printed circuit board panels 12 are arranged on a tooling plate 14 for machining, which normally comprises drilling and may also include milling. Each stack of panels 12 is substantially rectangular with a short side 16 extending in the X direction of the machine 10 and a long side 18 extending in the Y direction. The stacks are longitudinally spaced from each other in the X direction. The bottom board 12′ of each stack and stacked boards successively laid thereon may be connected and clamped to the associated tooling plate 14 and each other in a known manner.

Machine 10 comprises a number of machining heads each having a tool holder spindle 20 that can be mounted for movement on a common carriage 22 which is moved in the X direction by a numerically controlled servo motor (not shown). Machine 10 also comprises a machine base 24, preferably in the form of a granite structure, supporting a worktable 26 movable along the coordinate axis Y by a further numerically controlled servo motor (not shown). Each spindle 20 is also movable vertically along a vertical axis Z (e.g. for drilling) by a third numerically controlled servo motor (also not shown).

The worktable 26 is preferably comprised of a pair of parallel beams 27a and 27b extending in the X direction of the drilling machine 10. These beams may be rigidly connected together with a plurality of X-shaped trusses 29 extending between the beams in the X-Y plane. Various supporting brackets and locking cylinders described below are attached to exterior and interior vertical surfaces of each beam for purposes described hereinbelow.

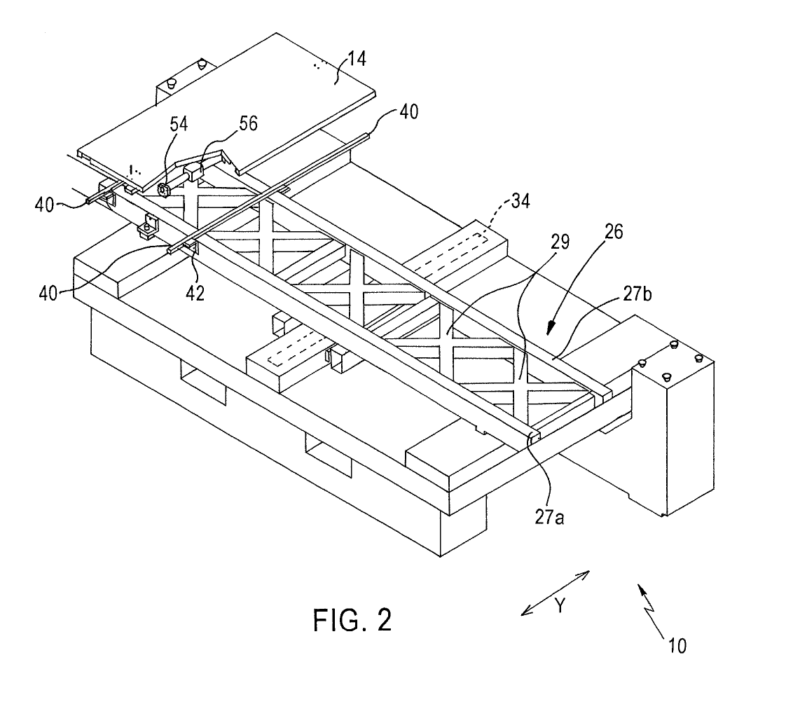

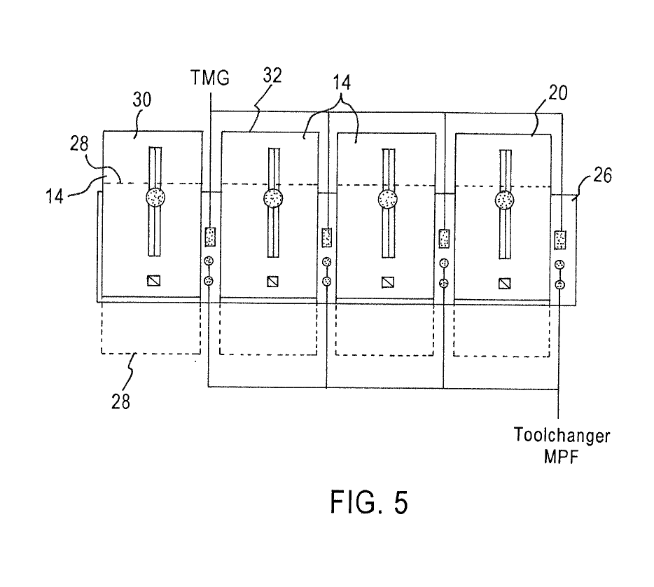

FIGS. 2 and 5 are perspective and schematic top plan views, respectively, of one preferred embodiment in which four longitudinally spaced, preferably identical tooling plates 14 (defining a four station machine) are uniquely movably mounted to the worktable 26 for movement along the Y axis into first and second positions relative to the worktable. The tooling plate first position is depicted by dotted lines 28 in FIG. 5 and the tooling plate second position is depicted by solid lines 30. In the tooling plate first position 28, it will be appreciated that the associated spindle 20 overlies one end of the printed circuit board panel 12 proximate the short edge 32 of the tooling plate 14 closest to the overhead common carriage 22 supporting the spindles so that movement of the spindles in the X direction, coordinated with movement of the worktable 26 in the Y direction (during which the tooling plate 14 is locked to the worktable in the first position 28 for movement therewith) achieves drilling of holes in one end portion of the panels then beneath the spindle. In the tooling plate second position 30, it will be appreciated that the center of the tooling plate 14 (and thereby the panel(s) 12 fixedly clamped thereto) has shifted towards the spindle axis to provide spindle access along the other remaining portion of the panels 12 (located furthest from the short edge 32). In this manner, spindle access along the entire panel length is advantageously provided simply by shuttling the tooling plate(s) 14 along the Y axis between the first and second positions 28,30 relative to the worktable 26. In one preferred embodiment, a shift of the tooling plates 14 between the first and second positions 28,30 by approximately 20″ will provide spindle access along the entire panel length in nominal panel sizes of up to 72″ (30″×60″, 30″×72″ panels, etc.).

As is well known, the drilling spindles 20 are moved in the X direction and Z direction with separately controlled servo motors and no further discussion of the control methodology or related structure is necessary for a complete understanding of the invention therein. Similarly, the manner in which the worktable 26 moves in the Y direction under the guidance of a further computer controlled servo motor in coordination with the controlled spindle movement to achieve a predetermined pattern of holes in the panel is well known. Therefore, description will now be provided as to the manner in which the tooling plates 14 are each uniquely movably mounted and locked to the worktable 26. Description of the mounting relation between only one of the tooling plates 14 with worktable 26 will now be provided herein since identical mounting and moving relationships for the other tooling plates are contemplated.

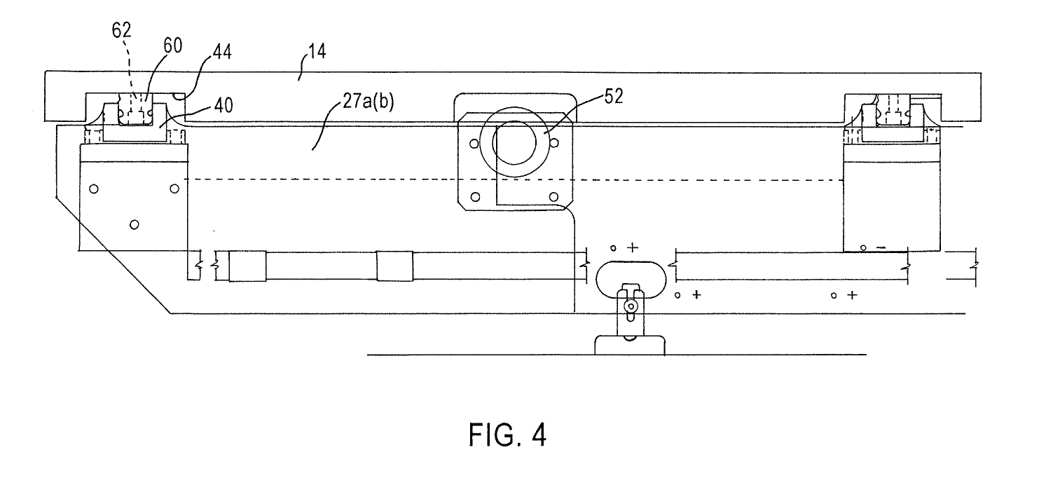

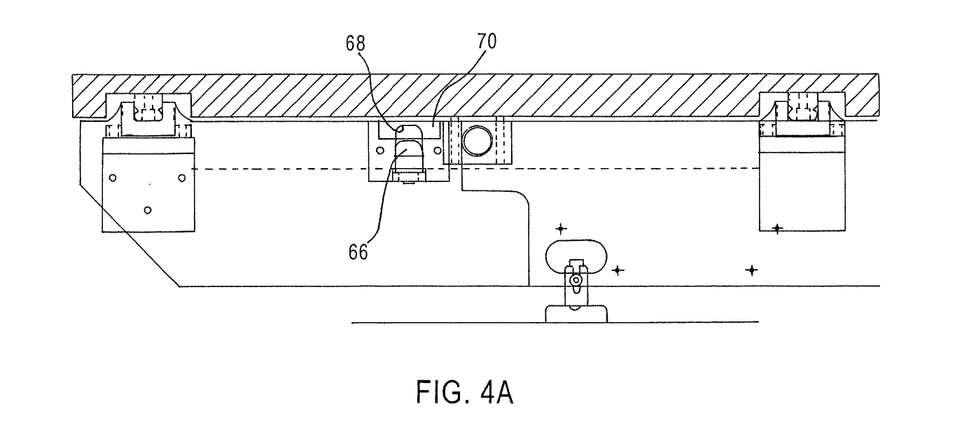

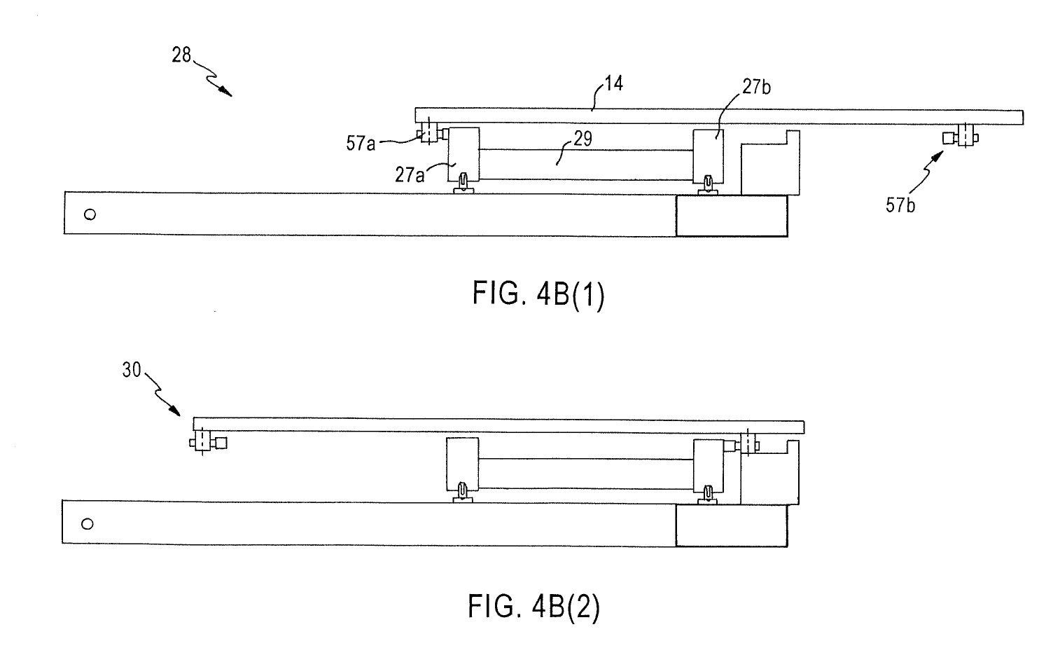

With reference to FIG. 2, there is disposed a lead screw, schematically identified with reference numeral 34 extending in the X direction, to move the worktable 26 along coordinate axis Y in the known manner described above. To provide unique movement in the Y direction between tooling plate 14 and worktable 26, a pair of parallel rails 40 are fixedly mounted to the beams 27a,27b with supporting brackets 42 attached, for example, to the vertical longitudinally extending exterior surfaces of each beam. These rails 40 are respectively received in a pair of channels 44 (see FIG. 4) formed in the bottom surface of each tooling plate 14 that extend parallel to one of the long sides of the tooling plate. The channel 44 width receiving the associated rail 40 need not have close tolerance to provide a snug interfitting sliding relationship therebetween. Instead, a guide member 60 secured to the channel bottom with a screw 62 and having a snug fitting yet smooth sliding relationship with the rail channel may be provided.

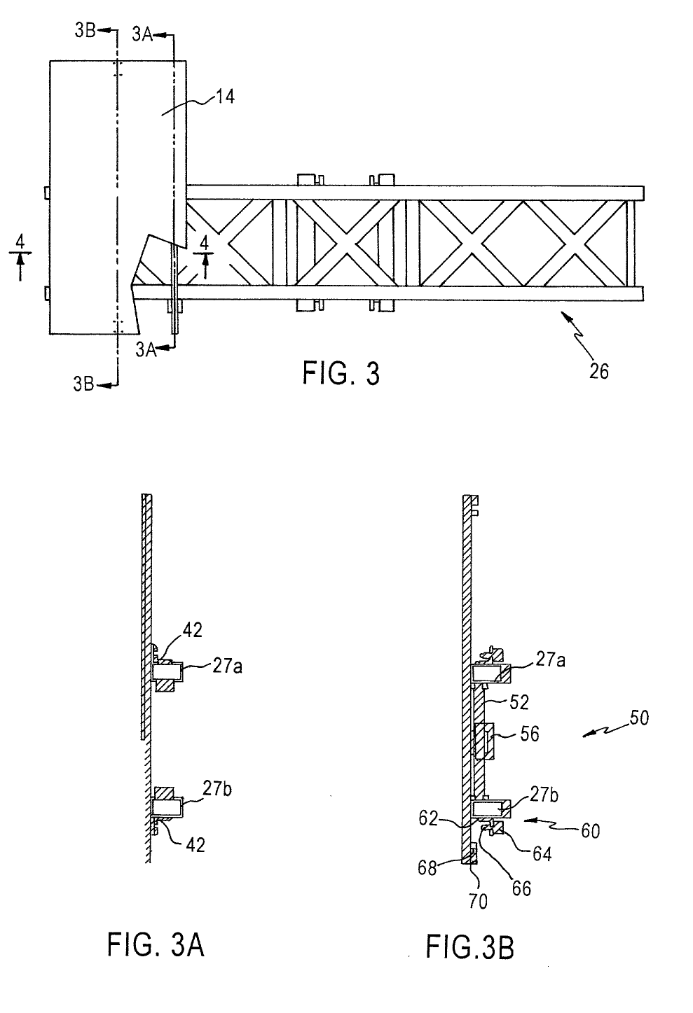

To enable the tooling plate 14 to slide along the pair of rails 40, the preferred embodiment of the invention contemplates a moving mechanism 50 that is comprised of a cylinder 52 extending in the Y direction between the inner vertical surfaces of the pair of beams 27a,27b. Opposite ends of the cylinder rod 52 are received within an associated cylinder support bracket 54 fixed to the inner vertical surface of the associated beam as best depicted in FIGS. 2 and 3B. A cylinder block 56 slidable along the cylinder 52, with reference to FIG. 3B, is fixedly secured to the bottom surface of the tooling plate 14. In the preferred embodiment, the cylinder 52 is hollow and includes a magnetic piston (not shown) that is actuated by pressurized working fluid provided through an air inlet port in each of the ends of the cylinder to thereby move the magnetic piston in the Y direction between two end positions defined at opposite ends of the cylinder. The cylinder block 56 also includes magnetic material so that movement of the magnetic piston within the cylinder 52 under air pressure causes corresponding movement of the cylinder block and thereby the tooling plate 14 to achieve one or the other of the first and second positions 28,30.

In the preferred embodiments, the air inlet ports are preferably provided in the support brackets 54 which may be formed with a fluidic passage in fluid communication with the cylinder 52 interior to enable air pressure to be alternately applied to either side of the magnetic piston. In this manner, the cylinder block 56 is always moved to one end or the other of the cylinder 52 to provide accuracy in defining the first or second position. However, with reference to FIG. 4B, the first or second positions may also be defined by means of shock absorbing mechanisms 57a and 57b respectively mounted to opposite short ends of the associated tooling plate 14 against the bottom surface thereof to effect a resilient shock absorbing contact as the tooling plate is moved into either the first or second end position under the action of the above-mentioned cylinder arrangements (not shown in FIG. 4B for ease of viewing). These shock absorbing mechanisms 57a, 57b respectively contact one of beams 27a,27b as the associated tooling plate 14 reaches one of the first or second end positions 28,30. Thus, the first or second position may be defined by cylinder block 56 contacting one end or the other of the cylinder 52, or by providing respective end of position contact utilizing shock absorbing members 57a,57b, or through a combination thereof. In the latter instance, the end position 28,30 of tooling plate 14 is achieved with the cylinder block 56 and cylinder 52 arrangement, and as the cylinder block reaches an end of stroke position at one end or the other of the cylinder 52, the final contact is buffered as a result of shock absorbing resilient contact between the associated shock absorber 57a or 57b with the beam 27a or 27b.

Although the preferred embodiment contemplates the rodless cylinder 52 and magnetically actuated cylinder block 56 arrangement described hereinabove, it will be appreciated that other moving mechanisms are possible. For example, it is possible to control movement between the tooling plate 14 and worktable 26 with a ball and lead screw arrangement. This will result in an accurate moving mechanism but is usually more expensive to manufacture than the cylinder block mechanism described hereinabove. It is also possible to use a motor and gear arrangement but this tends to be noisy, expensive, and subject to inaccuracies in movement as a result of backlash or play. It is also possible to use a belt and pulley arrangement although the belt may be subject to stretching or breakage.

Once the tooling plate 14 is moved into one or the other first or second position 28,30, a locking mechanism 60 is utilized to interlock the tooling plate with the worktable to prevent relative movement therebetween. In one embodiment, the locking mechanism 60 includes a bracket 62 secured to an exterior vertical surface of the worktable 27a. A locking cylinder 64 is mounted to the bracket 62 and includes a locking pin 66 that is movable upwardly through the bracket along the Z axis when the cylinder 64 is actuated to engage a downward facing opening 68 formed in a locking block 70 mounted to the bottom surface of the tooling plate 14. This locking pin 66 is therefore raised upwardly to engage this downward facing opening as best depicted in FIGS. 3B and 4A to provide the desired interlocking after the tooling plate 14 has been moved into the first or second position in the manner described above.

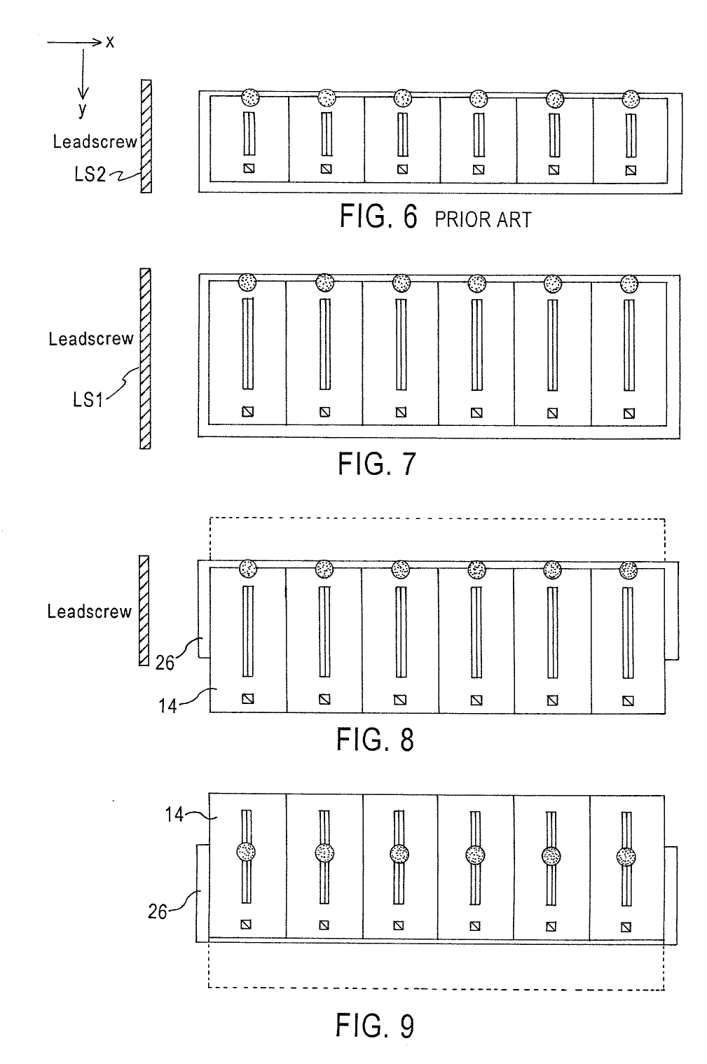

FIG. 6 is a depiction of a known worktable and tooling plate arrangement in which the tooling plate is not capable of Y axis movement into first and second positions in the unique manner described above. Therefore, the drilling machine incorporating the FIG. 6 mechanism is incapable of drilling along the entire length of large panel sizes (e.g. 60″-72″ in length).

The arrangement depicted in FIG. 7 is functionally and structurally similar to the FIG. 6 arrangement but is manufactured with a longer lead screw and a longer tooling plate in the Y direction to accommodate larger sizes. A potential problem with this type of arrangement relates to the production of larger machines and attendant difficulties in transportation thereof, as well as more expensive production costs.

FIGS. 8 and 9 of the invention, already discussed extensively above, highlight the use of a shorter lead screw and tooling plate length while achieving sufficient movement to enable drilling of larger panel sizes. It will be further evident that the invention embodied in FIGS. 8 and 9 and elsewhere herein can be easily incorporated into existing machines corresponding to FIG. 6, for example, through retrofitting to incorporate the moving tooling plate assemblies and mechanisms, as well as locking mechanisms therefor as will be evident from this disclosure.

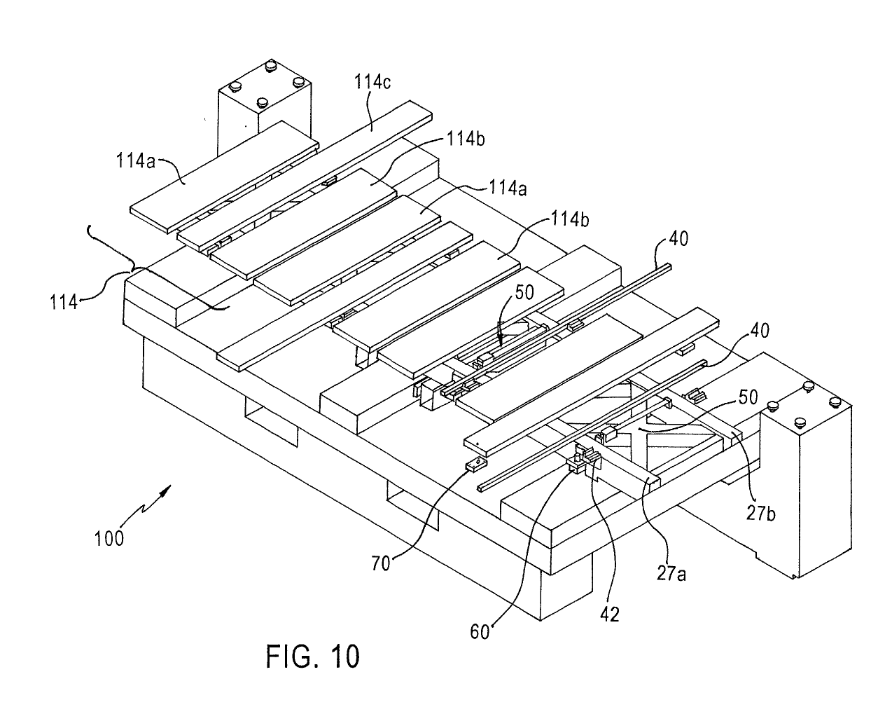

FIG. 10 is an illustration of an alternative preferred embodiment in relation to the FIG. 2 embodiment in which all components are virtually identical with the following exceptions. First, whereas the FIG. 2 embodiment features individual tooling plates 14 each consisting of a solid tooling plate member of rectangular proportions, each tooling plate 114 in the FIG. 10 embodiment may be comprised of a pair of stationary filler plates 114a fixedly attached to work table beams 27a,27b, and a moveable registration plate 114c extending between the associated stationary filler plates 114a,114b for movement in the Y direction in a manner similar to tooling plates 14 of the FIG. 2 embodiment. In other words, the primary difference between the FIGS. 2 and 10 embodiments is that the entire tooling plate 114 in the FIG. 10 embodiment does not move (i.e., filler plates 114a,114b are stationary), while only the registration plate 114c is free to move in the manner described above.

The mechanisms for moving each registration plate 114c are substantially identical to the mechanisms described in detail in relation to the FIG. 2 embodiment. The primary difference is that, instead of two rails 40 being associated with each tooling plate 14 in the FIG. 2 embodiment, only one rail 40 need be mounted to work table beams 27a,27b with trucks or supporting brackets 42. Although not shown, the rail 40 associated with each one of registration plates 114c is slidably received in a single pair of channels 44 mounted at opposite ends of the associated registration plate in the Y direction to provide a smooth sliding relationship between the registration plate and the rail. Thus, each registration plate 114c is supported by a single rail 40. The moving mechanism 50 associated with the FIG. 2 embodiment is located beneath the associated registration plate 114c in adjacent spaced relationship to the rail 40 as is evident with reference to FIG. 10. Although not shown, shock absorbing buffers 57a,57b may also be secured to the bottom surface of each registration plate 114c to provide buffered or shock absorbing contact as each registration plate reaches one of the first or second end positions 28,30.

FIG. 10 has a number of advantages in relation to the FIG. 2 embodiment. One advantage, for example, is that less tooling plate mass is being moved in the FIG. 10 embodiment. This enables either fewer and/or less expensive components to be used. Another advantage is that each individual tooling plate assembly 114 may be easier to repair in that it is easier to switch out a damaged filler plate 114a or 114b as opposed to removal or replacement of an entire damaged tooling plate 14.

Although pneumatic air cylinder drives 50 are utilized in the FIGS. 2 and 10 embodiments for moving the tooling plate 14 or registration plate 114c as described above, the invention also contemplates the use of other drive mechanisms. For example, belt drive mechanisms, electric motor drives as well as other types of moving mechanisms as known in the art are contemplated and are deemed to fall within the scope of this invention.

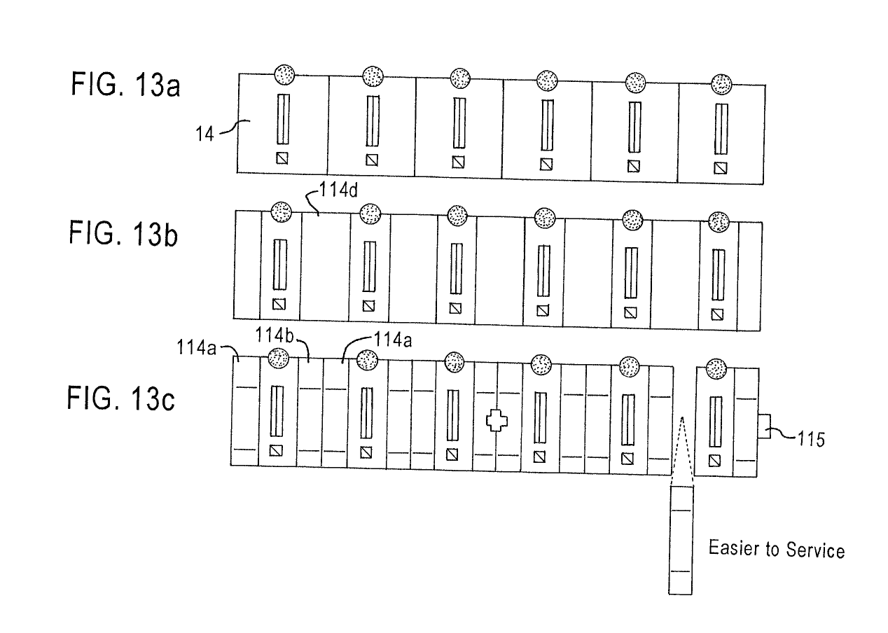

Since adjacent filler plates 114b,114a respectively associated with adjacent one of tooling plate assemblies 114 are stationary structures, the invention also contemplates replacement of such separate filler plates 114b,114a with a single, larger registration plate generally designated with reference number 114d such as depicted in FIG. 13B of the drawing.

In either the FIG. 10 or 13B embodiments, registration plates 114c may be of the same or different lengths in relation to the filler plates 114a,114b or 114d. For example, for illustration purposes only, registration plates 114c in FIG. 10 are depicted as being longer than the associated filler plates while, in each of FIGS. 13D and 13C the registration plates are depicted as being of the same length as the associated filler plates. Depending on the length of panels to be drilled, it may be desirable to utilize moveable registration plates 114c that are greater length than the associated filler plates.

It will be apparent to persons skilled in the art from this disclosure that tooling plates 14 or registration plates 114c will also contain one or more types of positioning pins and clamping assemblies as known in the art. These additional assemblies have been omitted from the drawings to avoid clutter and for simplicity of illustration of the essential component parts of the present invention in its different embodiments.

The modularized tooling plate concepts achieved with either the FIG. 10, 13B or 13C embodiments are not limited only to the use of filler plates 114a, 114b or 114c of the same different size in relation to the registration plate 114c, but also advantageously promotes the use of other modules such as the use of edge clamp modules, (schematically shown as 115 in FIG. 113C) and other modules that can be added which are not registration sensitive. Thus, another important preferred aspect of the present invention which is unique is the securement of the registration apparatus to the work table 26 one time and the novel ability to change out other parts of the tooling plate assembly 114 for different functions without disturbing the registration alignment.

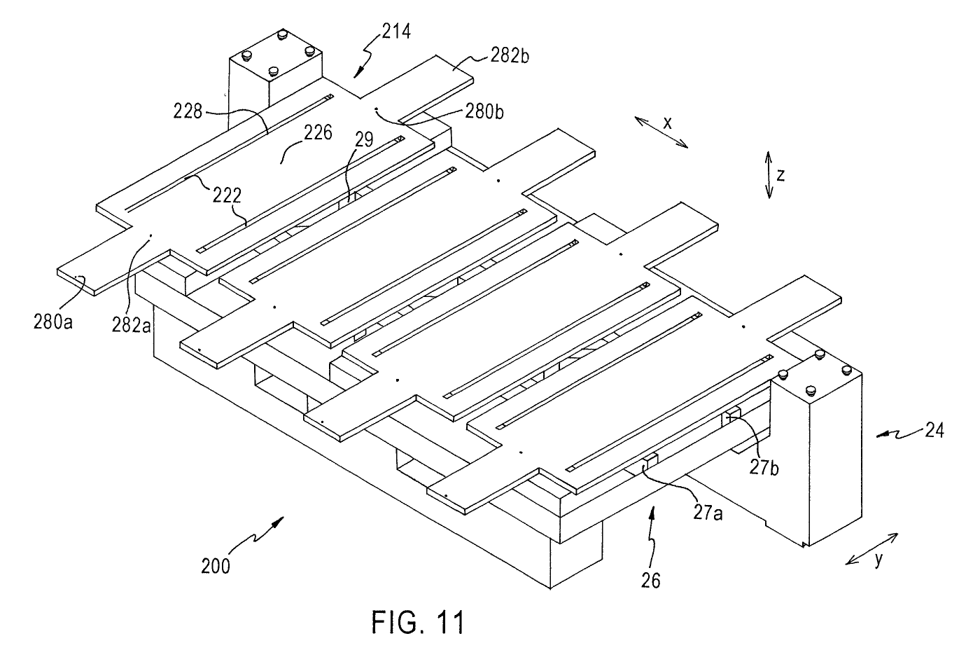

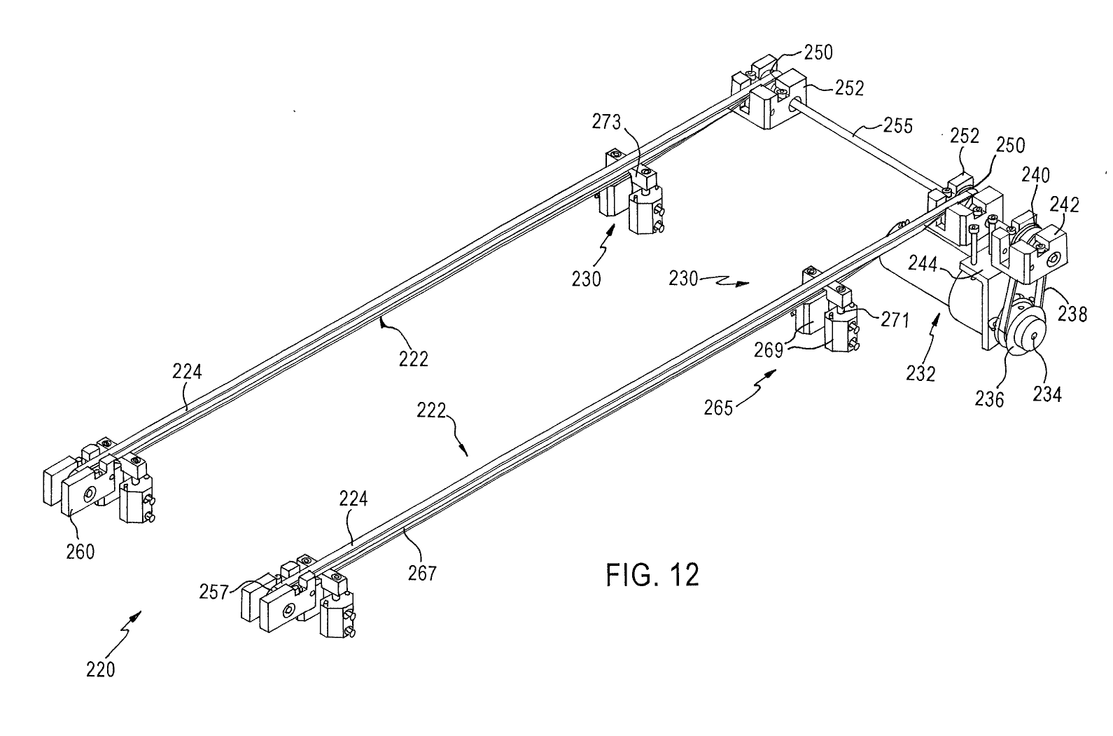

FIGS. 11 and 12 are illustrations of yet another embodiment of a drilling machine 200 according to the invention which is similar to machine 10 in that it comprises a number of machine heads, each having a tool holder spindle 20 (not shown in FIG. 11) that can be mounted for movement on an overhead common carriage 22 (also not shown for viewing ease) which is moved in the X direction by a numerically controlled server motor (not shown). Machine 200 also comprises a machine base 24, preferably in the form of a granite structure, supporting a work table 26 moveable along the coordinate axis Y by a further numerically servo motor (not shown). Each spindle is also moveable vertically along a vertical axis Z (e.g., for drilling) by a third numerically controlled servo motor (also not shown).

As with the embodiments of machines 10,100, the work table 26 may also be comprised of a pair of parallel beams 27a,27b extending in the X direction of the drilling machine 200. These beams 27a,27b may be rigidly connected together with a plurality of X-shaped trusses 29 extending between the beams in the XY plane.

FIG. 11 is a perspective view of one preferred embodiment of machine 200 in which four longitudinally spaced, preferably identical tooling plates 214 (defining a four station machine) are fixedly mounted to the work table 26, unlike the moveable tooling plate embodiments schematically depicted in FIGS. 13A-13C. To provide unique movement of one or more panels into the first and second positions 28,30 and achieve such unique positioning with the FIG. 11 embodiment of machine 200, each stationary tooling plate assembly 214 includes a belt drive system (generally designated with reference number 220 in FIG. 12) having a pair of spaced apart parallel belts 222 extending in the Y direction. Each belt 222 has an upper run 224 exposed to the top surface 226 of the tooling plate 214 through a longitudinally extending continuous slot 228 extending in the Y direction through the plate. In a rest or lower position, the top surface of each conveyor upper run 224 is disposed at or below the tooling plate top surface 226. Advantageously, however, when acted upon by a pair of pop-up cylinder assemblies 230 (see FIG. 12), each conveyor upper run 224 is both forcibly lifted and maintained by the pop-up cylinder assembly in a raised position located above the tooling plate top surface 226. In this raised position, it will be appreciated that the conveyor belt upper runs 224 exert a strong frictional pressing contact with the bottom surface of the panel (or bottommost panel in a stack), whereupon the conveyor belts 222 are driven under the action of drive motor 232 to advance the panel or stack to one or the other of the first and second positions 28,30.

Although not shown in detail, the conveyor belt drive assembly 220 is fixed to the work table 26 so as to be moveable therewith during drilling under the action of lead screw 34. For that purpose, the drive motor 232 is supported by suitable framing (not shown) connected to the work table 26. Drive motor 232 includes an output shaft 234 having a horizontal axis of rotation and which is connected via a pulley 236 mounted thereon and a drive belt 238 to a drive pulley 240 mounted within a bearing block 242 attached to the motor housing through an L-shaped support bracket 244. The motor drive is transmitted from drive pulley 240 to a pair of driven pulleys 250, through a horizontal drive shaft 255 extending in the X direction. These driven pulleys 250 are mounted within respective bearing blocks 252 (also supported by work table 26 through suitable framing for movement with the work table) which are spaced from each other in the X direction to define one end (located closest to spindles 20) of each conveyor belt run. The opposite ends (i.e. located furthest from spindle assemblies 20) are trained around a further set of driven pulley members 257 also having a horizontal axis of rotation in the X direction that are rotatably supported by another set of bearing blocks 260 mounted through suitable framing (not shown) to, and for movement with, the work table 26.

Each conveyor belt 222 supports two pairs of pop-up type cylinder units, generally designated with reference number 265, that are fixedly mounted to the lower run 267 of each belt at spaced intervals from each other in the Y direction. Each pop-up cylinder assembly 265 is preferably comprised of a pair of piston/cylinder arrangements 269 respectively containing an upwardly projecting piston rod 271 moveable upward and downward in the Z direction under the action of a pneumatic working fluid supplied to the cylinder units in a known manner. The upper ends of each piston rod 271 are fixed to a lifting bar or plate 273 that extends in the X direction between the upper and lower runs 224,267 of each belt 222 to selectively engage and push up the lower surface of the upper run 224 to cause frictional engagement with the panel in this upper position. Once the frictional engagement has occurred, drive motor 232 is actuated under appropriate command so that the turning belts 222 advance the associated pair of pop-up cylinder units 265 in unison to move the panels from first position 28 to second position 30 and vice versa. Once moved to the appropriate first or second position, the pop-up cylinders 225 are actuated to enable piston rods to 271 to retract and thereby lower the conveyor upper runs 224 into positions within the associate slot 228 beneath tooling plate top surface 226.

Each tooling plate 214 further includes two pairs of registration pin locations respectively defined by two pairs of longitudinally spaced through holes (280a and 280b, and 282a and 282b (in the Y direction), for receiving a vertically moveable locking registration pin adapted to project upwardly from tooling plate top surface 226. When a panel is resting on tooling plate top surface 226 in either the first position or second position 28,30, one set of locking pins extending through either registration holes 280a,280b (in the first position 28) or 282a,282b (in the second position 30) extend into corresponding holes formed in the panel bottom surface in order to positively lock the panel into a fixed position on the tooling plate. After a part of the panel closest to the drilling spindle 20 has been drilled, the belt upper runs 224 will pop-up so that the lifting bars 273 will push the panel upwardly out of engagement with the corresponding set of locking pins. The belts 222 are then rotated with drive motor 232 to convey the panel into the other of the first or second positions, whereupon the belt upper runs 224 are then lowered below the tooling plate upper surface 226 by appropriate pneumatic lowering of each piston rod 271. As the panel is lowered back onto the surface of the tooling plate upper surface 226, the next set of registration pins (i.e., either 280a,280b or 282a,282b) will now be in vertical alignment with the two holes formed in the panel bottom surface so as to retain and positively register the panel on the tooling plate in this new panel first or second position.

In the preferred embodiment described above, the pop-up cylinder arrangements 265 perform the dual function of disengaging the panel from the registration pins and then move the panel to and between the first and second positions 28,30. However, other methods may be used to ensure positive disengagement of the panel from the pins when the panel is raised by the belt drive mechanism 220. For example, separate ejector pins (not shown in detail) may be used to disengage the panel from the registration pins. It is believed that such ejector pins may be a more reliable means to positively disengage the panel from the registration pins.

Although each tooling plate 214 is disclosed as having reduced with ends, it is also possible to utilize tooling plates of rectangular construction.

It is also within the scope of this invention to provide an overhead mechanism (not shown) in order to push down on the panel top surface after it is conveyed to the next first or second position to ensure positive engagement with the next set of registration pins.

Since the moveable belts 222 provide the panel repositioning movement in the FIG. 11 embodiment, the tooling plates are fixed to the work table 26 for movement therewith during drilling under the action of lead screw 34, i.e., only after the belts operate to move the panels to the first or second position. It will be understood that once the panels are moved, the belts do not operate during drilling operations.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

What is claimed is:

1. Apparatus for performing a machining operation (e.g., mechanical or laser or chemical) on at least one panel shaped workpiece, comprising:
(a) a support base;
(b) a worktable mounted to the support base;
(c) at least one tooling plate movably mounted to the worktable and adapted to support said panel shaped workpiece; and
(d) at least one tooling element movably mounted in relation to the tooling plate and being operable to perform said machining operation; wherein said tooling plate is movable between first and second positions relative to said worktable to thereby move said panel workpiece therewith and expose different end portions of said panel to said machining operation.

2. Apparatus of claim 1, wherein the movement of said tooling plate between the first and second positions enables substantially the entire length of said panel to be exposed to said machining operation.

3. Apparatus of claim 2, wherein the tooling element is movable along an X axis and a Z axis and the tooling plate is movable along a Y axis.

4. Apparatus of claim 3, wherein the worktable is movable along the Y axis.

5. Apparatus of claim 4, further comprising a locking mechanism between the worktable and the tooling plate for locking the tooling plate in one of said first or second positions.

6. Apparatus of claim 5, wherein the tooling plate is locked into one of said first and second positions during movement of the worktable in the Y direction.

7. Apparatus of claim 6, wherein the tooling element includes a spindle supporting a drill, and the panel is a printed circuit board panel.

8. Apparatus of claim 7, wherein the printed circuit board panel has nominal dimensions of 30″×60″ or 30″×72″, with the longer dimension oriented in the Y direction.

9. A method of performing a machining operation on at least one panel shaped workpiece, comprising the steps of:
(a) positioning the workpiece on a tooling plate;
(b) moving a tooling element into machining contact with an end portion of said workpiece;
(c) after completing a machining portion on said one end of said panel workpiece with said tooling element, moving said panel to locate the other end portion of said panel beneath said tooling element; and
(d) commencing machining contact between said tooling element and said other end portion of said panel.

10. Apparatus for performing a machining operation on at least one panel shaped workpiece, comprising:
(a) a supporting arrangement for supporting said panel shaped workpiece beneath a tooling element movably mounted to the supporting arrangement in an X and Z direction; and
(b) a mechanism for moving said panel shaped workpiece in a Y direction to successively locate different end portions of said panel shaped workpiece beneath said tooling element.

11. Apparatus of claim 10, wherein said mechanism for moving the panel shaped workpiece enables substantially the entire length of said panel to be exposed to said machining operation.

12. The method of claim 9, wherein said panel is moved by moving the tooling plate from a first position to a second position.

13. The method of claim 12, wherein the tooling plate is moved in a Y direction.

14. The method of claim 13, wherein only a portion of the tooling plate is moved.

15. The method of claim 9, wherein said panel is moved in a Y direction in relation to a stationary tooling plate.

16. The method of claim 15, wherein the panel is moved on a conveyor belt located in the tooling plate.

17. The method of claim 13, wherein the tooling plate slides in the Y direction.

18. Apparatus of claim 1, wherein said tooling plate includes a stationary portion and a moveable portion, said moveable portion including a registration plate.

19. Apparatus of claim 18, wherein said stationary portion is a filler plate.

20. Apparatus of claim 19, wherein a pair of said filler plates are disposed on opposite sides of the registration plate in the X direction.

21. Apparatus of claim 20, wherein a plurality of said tooling plate assemblies are disposed in the X direction, each assembly including a said registration plate and a pair of said filler plates.

22. Apparatus of claim 20, further comprising a plurality of said tooling plate assemblies arranged in an X direction, each assembly including a said registration plate and a filler plate disposed between adjacent registration plates.

23. Apparatus of claim 10, wherein said moving mechanism is operable only after a plurality of holes are formed in one of the end portions.

24. Apparatus of claim 10, further comprising a work table and a tooling plate stationarily mounted to the work table, and a conveyor mechanism including a conveyor belt mounted to the tooling plate.

25. Apparatus of claim 24, further comprising a pair of said conveyor belts mounted respectively within a pair of slots formed in the tooling plate and extending in a Y direction, and a belt drive mechanism mounted beneath the tooling plate for driving said pair of belts.

26. Apparatus of claim 25, further comprising a lifting mechanism positioned to contact an upper run of the belt to press the same against a bottom surface of the panel.
